(19) United States
(12) Patent Application Publication
(10) Pub. No.: US 2014/0379271 A1
(43) Pub. Date: Dec. 25, 2014

(54) SYSTEM AND METHOD FOR ALIGNING GENOME SEQUENCE

(71) Applicant: SAMSUNG SDS CO., LTD., Gangnam-Gu (KR)

(72) Inventor: Min Seo PARK, Seoul (KR)

(73) Assignee: SAMSUNG SDS CO., LTD., Gangnam-Gu (KR)

(21) Appl. No.: 14/309,608

(22) Filed: Jun. 19, 2014

(30) Foreign Application Priority Data
Jun. 20, 2013 (KR) 10-2013-0070848

(51) Int. Cl. G06F 19/22

(52) U.S. Cl. CPC G06F 19/22
USPC 702/19

(57) ABSTRACT

A system and method for aligning a genome sequence are provided. The system for aligning a genome sequence includes a seed generation unit configured to generate a plurality of seeds from an input read, a filtering unit configured to map the generated seeds to a reference sequence and select target seeds for global alignment from the mapped seeds in consideration of gaps between the mapped seeds, and an alignment unit configured to perform a global alignment of the read with the reference sequence in mapping positions in which the selected seeds are mapped to the reference sequence.

### CROSS-REFERENCE TO RELATED APPLICATION

This application claims priority to and the benefit of Korean Patent Application No. 2013-0070848, filed on Jun. 20, 2013, the disclosure of which is incorporated herein by reference in its entirety.

### BACKGROUND

1. Field

Exemplary embodiments of the present disclosure relate to technologies for analyzing a genome sequence of a chromosome.

2. Discussion of Related Art

A next-generation sequencing (NGS) method of producing a large amount of short sequences has rapidly replaced the Sanger's sequencing method due to low expense and rapid data generations. Also, a variety of programs for aligning an NGS sequence have been developed under the focus of accuracy.

The first step of sequence recombination is to map a read at an accurate position of a reference sequence using an algorithm for aligning a genome sequence. For this purpose, conventional algorithms for aligning a genome sequence are configured to map a seed having a certain length selected from a read to a reference sequence and perform global alignments of the other reads in a position in which the seed is mapped.

In the case of such conventional algorithms for aligning a genome sequence, the global alignments should be performed in all the candidate positions in the reference sequence obtained using the seed. However, the global alignment should be performed for an extended period of time since it has a degree of complexity of O(N²). Accordingly, when the global alignment is performed using the conventional techniques, especially, it has problems in that a time required to align a genome sequence increases exponentially with an increase in the number of candidate positions.

### SUMMARY

The present disclosure is directed to a system and method for aligning a genome sequence capable of enhancing a genome sequencing speed and accuracy by reducing the cycle number of global alignments in consideration of allowed error values and mapping positions in which the respective seeds obtained from a read are mapped to a reference sequence upon sequence alignment using the read input from a sequencer.

According to an aspect of the present disclosure, there is provided a system for aligning a genome sequence, which includes a seed generation unit configured to generate a plurality of seeds from an input read, a filtering unit configured to map the generated seeds to a reference sequence and select target seeds for global alignment from the mapped seeds in consideration of gaps between the mapped seeds, and an alignment unit configured to perform a global alignment of the read with the reference sequence in mapping positions in which the selected seeds are mapped to the reference sequence.

In this case, the filtering unit may select the seeds, in which the sum of the gaps between the seeds is less than or equal to a predetermined value, as the target seeds for global alignment from the seeds which are mapped to the reference sequence.

The filtering unit may select the seeds, which satisfies the following Expression, as the target seeds for global alignment from the seeds which are mapped to the reference sequence:

A≦MaxError+B

wherein A represents the sum of the gaps between the selected seeds in the reference sequence, B represents the sum of the gaps between the selected seeds in the read, and MaxError represents a maximum error bound.

The system may further include an exact matching unit configured to perform an exact matching of the input read with the reference sequence, and an error number estimation unit configured to estimate the number of errors for the read, which does not exactly match the reference sequence at the exact matching unit, when the corresponding read is aligned with the reference sequence. In this case, the seed generation unit may generate a plurality of seeds from the read when the estimated number of errors is less than or equal to a predetermined maximum error bound.

According to another aspect of the present disclosure, there is provided a method of aligning a genome sequence. Here, the method includes generating a plurality of seeds from an input read at a seed generation unit, mapping the generated seeds to a reference sequence and selecting target seeds for global alignment from the mapped seeds in consideration of gaps between the mapped seeds at a filtering unit, and performing, at an alignment unit, a global alignment of the read with the reference sequence in mapping positions in which the selected seeds are mapped to the reference sequence.

In this case, the selecting of the target seeds may be performed by selecting the seeds, in which the sum of the gaps between the seeds is less than or equal to a predetermined value, as the target seeds for global alignment from the seeds which are mapped to the reference sequence.

The selecting of the target seeds may be performed by selecting the seeds, which satisfies the following Expression, as the target seeds for global alignment from the seeds which are mapped to the reference sequence:

A≦MaxError+B

wherein A represents the sum of the gaps between the selected seeds in the reference sequence, B represents the sum of the gaps between the selected seeds in the read, and MaxError represents a maximum error bound.

The method may further include performing, at an exact matching unit, an exact matching of the input read with the reference sequence prior to generation of the seeds, and estimating, at an error number estimation unit, the number of errors for the read, which does not exactly match the reference sequence during the exact matching, when the corresponding read is aligned with the reference sequence. In this case, the generation of the seeds may be performed by generating a plurality of seeds from the read when the estimated number of errors is less than or equal to a predetermined maximum error bound.

### BRIEF DESCRIPTION OF THE DRAWINGS

The above and other objects, features, and advantages of the present disclosure will become more apparent to those of ordinary skill in the art by describing in detail exemplary embodiments thereof with reference to the accompanying drawings, in which:

FIG. 1 is a diagram showing a method 100 of aligning a genome sequence according to one exemplary embodiment of the present disclosure;

FIG. 2 is a diagram illustrating a process of calculating an mEB using the method 100 of aligning a genome sequence according to one exemplary embodiment of the present disclosure;

FIGS. 3 to 5 are diagrams illustrating cases in which seeds are extracted from a read according to exemplary embodiments of the present disclosure;

FIG. 6 is a diagram illustrating mapping of the seeds according to one exemplary embodiment of the present disclosure to a reference sequence and a process of selecting target seeds for global alignment;

FIG. 7 is a diagram illustrating a concept of gaps between the seeds according to exemplary embodiments of the present disclosure; and

FIG. 8 is a block diagram illustrating a system 800 for aligning a genome sequence according to one exemplary embodiment of the present disclosure.

### DETAILED DESCRIPTION OF EXEMPLARY EMBODIMENTS

Hereinafter, embodiments of the present disclosure will be described in detail with reference to the attached drawings. However, the embodiments of the present disclosure are merely an example and the present disclosure is not limited to the exemplary embodiments disclosed below.

When it is determined that the detailed description of known art related to the present disclosure may obscure the gist of the present disclosure, such detailed description will be omitted. The same reference numerals are used to refer to the same elements throughout the specification. Terminologies described below are defined considering functions in the present disclosure and may vary according to a user's or operator's intention or usual practice. Thus, the meanings of the terminology should be interpreted based on the overall context of the present specification.

Consequently, the technical spirit of the present disclosure is determined by the claims, and the following embodiments are merely a means of efficiently explaining technical concepts of the present disclosure to those skilled in the art to which the present disclosure pertains.

Prior to fully describing the exemplary embodiments of the present disclosure, first of all, the terms used in the present disclosure will be described, as follows. First, the term “read” refers to data on a genome sequence having a short length, which is output from a genome sequencer. The length of the read generally varies from 35 to 500 base pairs (bp) according to the kind of sequencers. In general, the DNA bases are represented by four alphabets; A, C, G, and T.

The term “reference sequence” refers to a genome sequence for reference used to produce the entire genome sequence from the reads. In the analysis of the genome sequence, the entire genome sequence is completed by mapping a large amount of reads output from a genome sequencer with reference to the reference sequence. In the present disclosure, the reference sequence may be a predetermined sequence (e.g., an entire human genome sequence, etc.) in the analysis of the genome sequence, or a genome sequence produced in the genome sequencer may also be used as the reference sequence.

The term “bases” are the smallest units used to constitute a reference sequence and a read. As described above, the DNA bases may be represented by the four alphabets; A, C, G, and T, each of which is expressed as a base. That is, the DNA bases are expressed as four bases. In the case of the reads, the DNA bases are also expressed as four bases. In the case of the reference sequence, however, it may be unclear which one of the bases A, C, G, and T is expressed as a base in a certain position due to various reasons (i.e., sequencing errors, sampling errors, etc.). In general, this unclear base is expressed as a separate alphabet N.

The term “seed” is a sequence that is used as a unit sequence when a read is compared with a reference sequence to map the read. In theory, to map a read to the reference sequence, a mapping position of the read should be calculated while sequentially comparing the entire read with the reference sequence starting from the first base of the reference sequence. However, such a method requires lots of time and computing power to map one read. Thus, a candidate mapping position of the entire read is first pointed out actually by mapping a seed, which is a fragment constituting a portion of the read, to the reference sequence, and the entire read is then mapped in the corresponding candidate mapping position (global alignment).

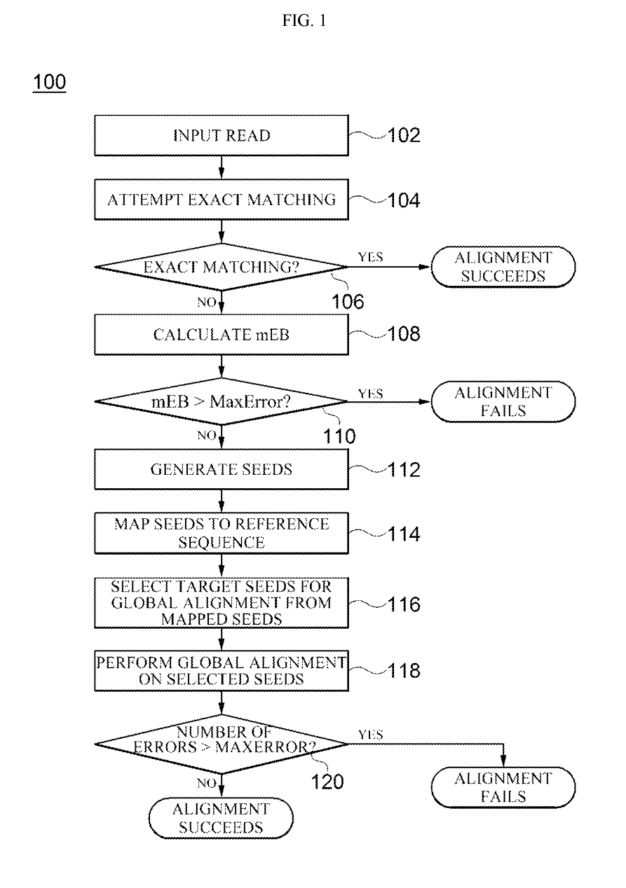

FIG. 1 is a diagram showing a method 100 of aligning a genome sequence according to one exemplary embodiment of the present disclosure. According to an exemplary embodiment of the present disclosure, the method 100 of aligning a genome sequence refers to a series of processes of comparing a read output from a genome sequencer with a reference sequence and determining a mapping position (or an alignment position) of the read with respect to the reference sequence.

When a read is input from a genome sequencer (102), first, an exact matching of the entire read with the reference sequence is attempted (104). When the results in operation 102 show that the exact matching of the entire read succeeds, the alignment of the read is judged to succeed directly without undergoing a subsequent alignment process (106). The results of experiments using a human genome sequence showed that, when one million reads output from a genome sequencer exactly matched the human genome sequence, 231,564 cycles of exact matching occurs in a total of two million cycles of alignments (i.e., one million cycles in the case of a forward sequence, and one million cycles in the case of a reverse complementary sequence). Therefore, from the results in operation 104, it could be seen that the requirements of alignments decreased by approximately 11.6%.

On the other hand, when the corresponding read is judged not to exactly match the reference sequence in operation 106, that is, when there is no region in which the read completely matches the reference sequence, then, the number of errors occurring when the corresponding read is aligned with the reference sequence is estimated (108).

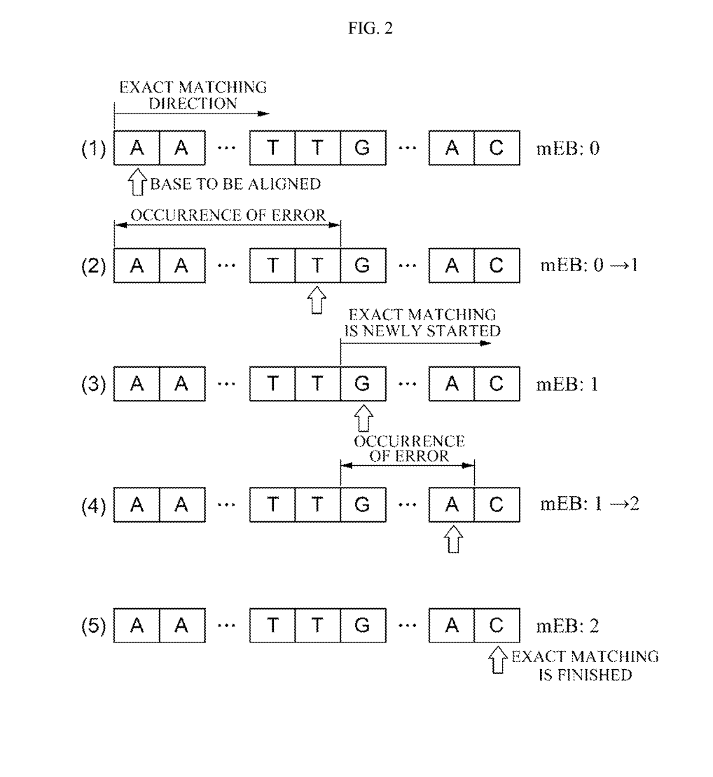

According to an exemplary embodiment of the present disclosure, an estimation of the number of errors may be achieved by calculating the minimum value of error (mEB; minimum Error Bound) which may occur when the read is aligned with the reference sequence. FIG. 2 is a diagram showing a process of calculating an mEB in operation 108. As shown in FIG. 2(1), first, an original mEB is set as 0, and the exact matching is attempted while the exact matching unit is moving from the first base of a read toward the last base of the read by one base. In this case, as shown in FIG. 2(2), when it is assumed that it is impossible to perform the exact matching from a certain base (indicated by an arrow in the drawing) of the read, it is indicated that an error occurs in any one base of the read between a matching start position and a present position. In this case, the mEB increases by 1, and the exact matching is newly started at the next position (shown in FIG. 2(3)). Thereafter, when it is judged that it is impossible to perform the exact matching at another certain position for the second time, it is indicated that another error occurs in any one base of the read between a position in which the exact matching is newly started and a present position. Therefore, the mEB increase again by 1, and the exact matching is newly started at the next position (shown in FIG. 2(4)). When the last base of the read is reached through this procedure, the mEB becomes the minimum value for the number of errors which may occur in the corresponding read.

When the mEB of the read is calculated through such a procedure, it is determined whether the calculated mEB is greater than a predetermined maximum error bound (MaxError) (110). Here, when the mEB is greater than the maximum error bound (MaxError), the alignment of the corresponding read is judged to fail. Then, the alignment of the read is finished. In the above-described experiments using the human genome sequence, the maximum error bound (MaxError) is set as 3, and mEBs of the other reads were calculated. As a result, it was revealed that the mEBs of the reads corresponding to a total 844,891 cycles of alignments were greater than the maximum error bound. That is, the results in operation 108 showed that the requirements of alignments decreased by approximately 42.2%.

On the other hand, when the judgment result in operation 110 shows that the mEB is less than or equal to the maximum error bound, the alignment of the corresponding read is performed, as follows.

First of all, a plurality of seeds are generated from the read (112), the respective generated seeds are mapped to the reference sequence (114), and target seeds for global alignment are selected from the mapped seeds in consideration of gaps between the mapped seeds (116). Thereafter, a global alignment of the read with the reference sequence is performed in the mapping positions in which the selected seeds are mapped to the reference sequence (118). In this case, when the results of the global alignments show that the number of errors in the read is greater than a predetermined maximum error bound (MaxError), the alignment is judged to fail. When the number of errors is less than or equal to the maximum error bound (MaxError), the alignment is judged to succeed (120).

Hereinafter, the specific procedure including operations 112 to 116 will be described in detail.

Generating a Plurality of Seeds from Read (112)

This operation is to generate a plurality of seeds that are small fragments from a read in order to perform an alignment of the read as a whole. In this operation, a plurality of seeds are generated in consideration of all or a part of the read. For example, the seeds may be generated by dividing the entire read or a certain section of the read into a plurality of fragments or combining the divided fragments. In this case, the generated seeds may be continuously ligated with each other, but the present disclosure is not limited thereto. For example, it is also possible to construct the seeds by combining the fragments which are separated from each other in the read. Also, it is unnecessary for the seeds generated from one read to have the same length, but it is possible to generate the seeds having various lengths from one read. According to the exemplary embodiments of the present disclosure, in brief, a method of generating seeds from a read is not particularly limited. For example, a variety of algorithms for extracting seeds from all or a part of the read may be used without limitation.

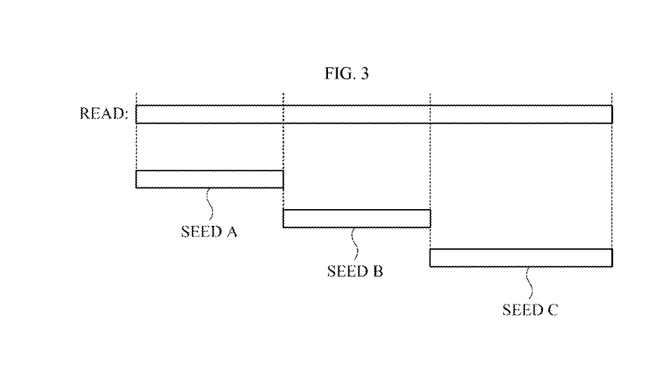

FIGS. 3 to 5 are diagrams illustrating cases in which seeds are extracted from a read according to exemplary embodiments of the present disclosure. For example, the seeds extracted as shown in FIG. 3 may be extracted from the read so that the seeds can be adjacent to each other. Also, the seed may be extracted from the read so that there are gaps between the seeds (indicated by “k₁” in the drawing) as shown in FIG. 4, or that the seeds overlap each other (indicated by “k₂” in the drawing) as shown in FIG. 5. The exemplary embodiments shown in the drawings disclose that three seeds are extracted from each read, but are described herein for the purpose of illustration only. Accordingly, the number of the seeds extracted from the read may be properly chosen in consideration of the length of the read, and the like.

### Mapping of Seeds and Selecting Target Seeds for Global Alignment (114 and 116)

When the seeds are generated from the read as described above, then, each of the generated seeds is mapped to the reference sequence (114), and the target seeds for global alignment are selected from the mapped seeds in consideration of gaps between the mapped seeds (116).

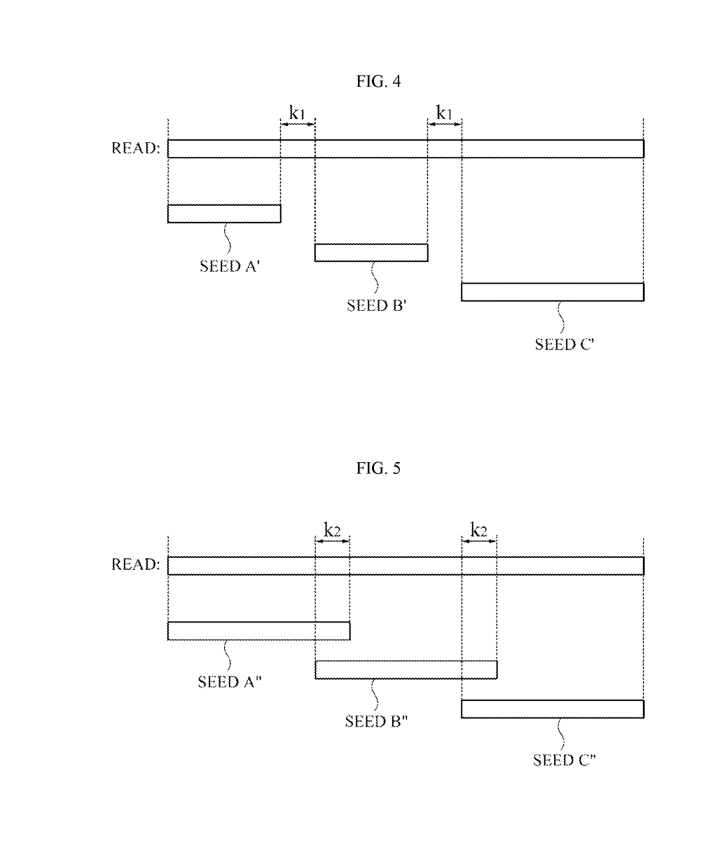

FIG. 6 is a diagram illustrating mapping of the seeds according to one exemplary embodiment of the present disclosure to a reference sequence and a process of selecting target seeds for global alignment. When it is assumed that three seeds (i.e., seed A, seed B, and seed C) extracted from the read are mapped to the reference sequence as in the exemplary embodiments shown in drawings, the respective seeds may be mapped to the reference sequence in one or more positions since the reference sequence has a highly longer length than the seeds. In the case of the exemplary embodiment shown in FIG. 6, seed A is mapped to the reference sequence in three positions, seed B is mapped to the reference sequence in two positions, and seed C is mapped to the reference sequence in one position.

When the mapping is completed, then, the target seeds for global alignment are selected from the seeds which are mapped to the reference sequence. According to an exemplary embodiment of the present disclosure, the target seeds for global alignment refer to seeds in which the sum of the gaps between the adjacent seeds is less than or equal to a predetermined value among the seeds which are mapped to the reference sequence. In this case, the reference value may be the maximum error bound (MaxError). Also, the adjacent seeds refer to seeds which are adjacent to each other on the read.

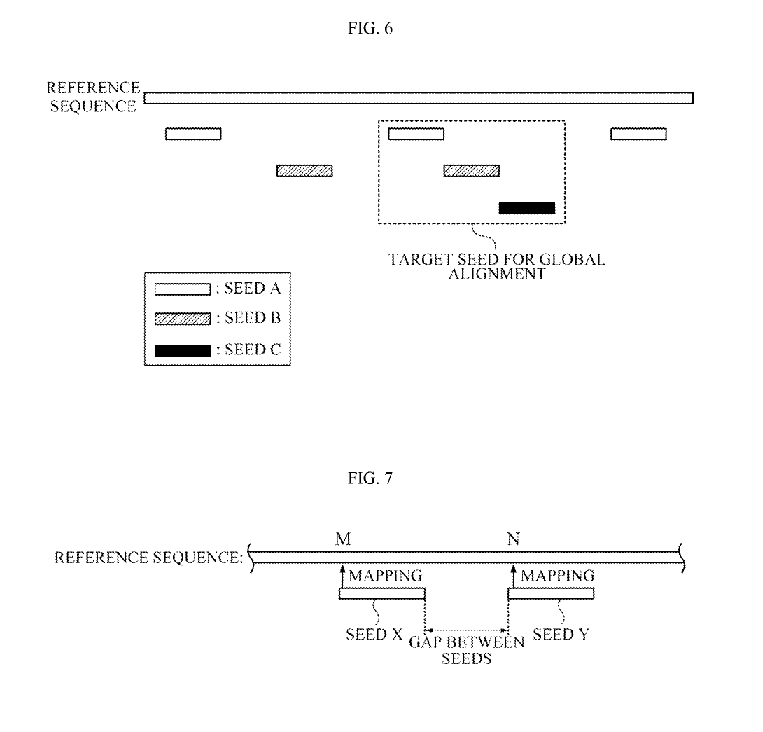

FIG. 7 is a diagram illustrating a concept of gaps between the seeds according to exemplary embodiments of the present disclosure. As shown in FIG. 7, when it is assumed that seed X and seed Y that are the seeds adjacent to each other on the read are mapped to the reference sequence in positions M and N, respectively, a distance between the last base of the first seed (i.e., seed X) and the first base of the second seed (i.e., seed Y) is a gap between the seeds according to the present disclosure.

According to an exemplary embodiment of the present disclosure, such a method is used to calculate gaps between the adjacent seeds among the seeds mapped to the reference sequence and select the seeds, in which the sum of the gaps between the seeds is less than or equal to the reference value, as the target seeds for global alignment. According to the exemplary embodiment shown in FIG. 6, for example, when it is assumed that the three seeds are adjacent in the read in the order of seed A, seed B, and seed C, a gap between seed A and seed B, and a gap between seed B and seed C are calculated, and a combination of seed A, seed B, and seed C in which the sum of the calculated gaps is less than or equal to a predetermined value is found and selected as a target seed for global alignment in operation 116 (the seeds marked by dotted lines are the target seeds for global alignment).

Meanwhile, according to an exemplary embodiment, when the extracted seeds are not ligated in the read but spaced apart by a certain gap as shown in FIG. 4, the reference value may be increased in consideration of this structure. That is, when it is assumed that a gap between two seeds is 5 when the seeds which are spaced apart by a gap of 2 in the read are mapped to the reference sequence, a gap of 3 is possibly due to insertion into the reference sequence, but the remaining gap of 2 is possibly due to the gap in the read itself. Therefore, it is reasonable to increase the original reference value by 2 in order to correct a difference in the gap. This is represented by the following Expression 1.

A≦MaxError+B [Expression 1]

wherein A represents the sum of the gaps between the selected seeds in the reference sequence, B represents the sum of the gaps between the selected seeds in the read, and MaxError represents a maximum error bound.

That is, in operation 116, when the sum of the gaps between the mapped seeds satisfies Expression 1, the corresponding seeds may be selected as the target seeds for global alignment. Also, MaxError is used as the reference value in Expression 1, but the present disclosure is not limited thereto. For example, a value greater than or less than the MaxError may be used as the reference value, as needed.

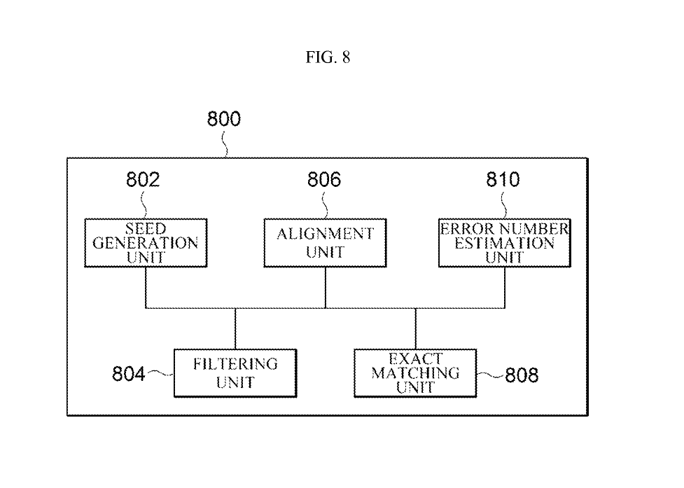

FIG. 8 is a block diagram illustrating a system 800 for aligning a genome sequence according to one exemplary embodiment of the present disclosure.

As shown in FIG. 8, the system 800 for aligning a genome sequence according to one exemplary embodiment of the present disclosure includes a seed generation unit 802, a filtering unit 804, and an alignment unit 806, and may further include an exact matching unit 808, and an error number estimation unit 810, as needed.

The seed generation unit 802 generates a plurality of seeds from a read input from a sequencer. As described above, various methods of generating a read can be performed in the present disclosure, and the exemplary embodiments of the present disclosure are not limited to certain methods of generating seeds.

The filtering unit 804 maps each of the generated seeds to a reference sequence, and selects the target seeds for global alignment from the mapped seeds in consideration of the gaps between the mapped seeds. In this case, the filtering unit 804 may select the seeds, in which the sum of the gaps between the adjacent seeds is less than or equal to a predetermined value, as the target seeds for global alignment from the seeds which are mapped to the reference sequence. If necessary, the gaps between the seeds in the read may be further considered during selection of the target seeds for global alignment. The specific method of selecting the target seeds for global alignment is as described above.

The alignment unit 806 performs a global alignment of the read with the reference sequence in mapping positions in which the selected seeds are mapped to the reference sequence.

Meanwhile, the system 800 for aligning a genome sequence according to one exemplary embodiment of the present disclosure may further include the exact matching unit 808 and the error number estimation unit 810, as described above. The exact matching unit 808 performs exact matching of a read input from a sequencer with the reference sequence. When there is a read exactly matching the reference sequence at the exact matching unit 808, the alignment of the corresponding read is judged to succeed without undergoing the other processes.

The error number estimation unit 810 estimates the number of errors for the read, which does not exactly match the reference sequence at the exact matching unit 808, when the corresponding read is aligned with the reference sequence. The specific algorithm for estimating the number of errors is as described above with reference to FIG. 2. When the estimation result at the error number estimation unit 810 shows that the number of errors is greater than a predetermined maximum error bound, the alignment of the corresponding read is judged to fail. On the other hand, when the estimated number of errors is less than or equal to the predetermined maximum error bound, the corresponding read is subjected to alignments performed at the seed generation unit 802, the filtering unit 804, and the alignment unit 806.

According to the exemplary embodiments of the present disclosure, the number of global alignments in which a degree of complexity is O(N²) may be effectively reduced by filtering the seeds, which have a low probability of being mapped to the read, among the seeds which are mapped to the reference sequence. The following Tables 1 and 2 list the experimental results for explaining the effects according to the exemplary embodiments of the present disclosure. Here, the experimental results are obtained by comparing the alignment speeds and mapping accuracies when ten million reads having lengths of 100 bp or less are aligned with the reference sequence.

TABLE 1

| | Prior-art | Present |
|---|---|---|
| | technique | disclosure |
| Alignment | 16382 s (4 h | 10627 s (2 h |
| speed | 33 m 2 s) | 57 m 7 s) |

TABLE 2

| | Prior-art technique | Present disclosure |
|---|---|---|
| Ratio (%) of aligned reads | 97.93% | 98.41% |
| Ratio (%) of aligned paired- | 99.24% | 99.40% |
| end reads | | |

According to the exemplary embodiments of the present disclosure, it could be seen that the alignment speed was improved by approximately 40%, compared to those obtained by the conventional techniques, as listed in Table 1. According to the exemplary embodiments of the present disclosure, it could also be seen that the mapping accuracy was also improved, as shown in Table 2, indicating that the seeds having low mapping probabilities were removed during the filtering of the mapped seeds.

Meanwhile, according to exemplary embodiments of the present disclosure, the system may include a computer-readable recording medium including programs executing the above-described methods on computers that have one or more hardware processors. The computer-readable recording medium may include program commands, local data files, local data structures, and the like, which may be used alone or in combination. The medium may be specially designed and configured for the present disclosure, or may include those known and available to those skilled in the field of computer software. Examples of the computer-readable recording medium include magnetic media such as a hard disk, a floppy disk, and a magnetic tape, optical recording media such as a CD-ROM and a DVD, magneto-optical media such as a floppy disk, and hardware devices such as a ROM, a RAM, and a flash memory, which are particularly configured to store and perform the program commands. Examples of the program commands may include high-level language codes executable by a computer using an interpreter, and the like, as well as machine language codes made by compilers.

According to the exemplary embodiments of the present disclosure, the global alignments are not performed in all the mapping positions in which the respective seeds obtained from the read are mapped to the reference sequence, but the global alignments can be performed only in the mapping positions in which the respective seeds are mapped to the reference sequence and the positions in which the error bounds are judged to be in an appropriate level in consideration of allowed error values, thereby enhancing a genome sequencing speed.

In addition, the global alignment can be performed only in the positions, among the mapping positions of the respective seeds, in which the read is considered to have a high probability of being aligned, other than the position in which the read is considered to have a low probability of being aligned, thereby improving accuracy in analyzing a genome sequence.

Although the present disclosure has been described through certain embodiments, it shall be appreciated that various permutations and modifications of the described embodiments are possible by those skilled in the art to which the present disclosure pertains without departing from the scope the present disclosure.

Therefore, the scope of the present disclosure shall not be defined by the described embodiments but shall be defined by the appended claims and their equivalents.

What is claimed is:

1. A system for aligning a genome sequence, comprising:
a seed generation unit configured to generate a plurality of seeds from an input read to provide generated seeds;
a filtering unit configured to map the generated seeds to a reference sequence to provide mapped seeds, and to select from the mapped seeds target seeds for a global alignment operation, in consideration of gaps between the mapped seeds; and
an alignment unit configured to perform the global alignment operation of the input read, with the reference sequence, in mapping positions in which the target seeds are mapped to the reference sequence
wherein one or more of the seed generation unit, the filtering unit, and the alignment unit is implemented using a hardware processor.

2. The system of claim 1, wherein the filtering unit is further configured to select as target seeds ones of the mapped seeds, in which the sum of the gaps between the mapped seeds is less than or equal to a predetermined value.

3. The system of claim 2, wherein the filtering unit is further configured to select as target seeds ones of the mapped seeds, satisfying the following Expression:
A≦MaxError+B
where:
A represents the sum of the gaps between the selected seeds in the reference sequence,
B represents the sum of the gaps between the selected seeds in the read, and
MaxError represents a maximum error bound.

4. The system of claim 1, further comprising:
an exact matching unit configured to perform an exact matching of the input read with the reference sequence; and
an error number estimation unit configured to estimate a number of errors for the read, responsive to an indication by the exact matching unit that the read sequence does not exactly match the reference sequence when aligned with the reference sequence,
wherein the seed generation unit generates the plurality of seeds from the read when the estimated number of errors is less than or equal to a predetermined maximum error bound.

5. A method of aligning a genome sequence, comprising:
generating a plurality of seeds from an input read, at a seed generation unit, to provide generated seeds;
mapping the generated seeds to a reference sequence, using a filtering unit, and selecting from the mapped seeds target seeds for a global alignment operation, in consideration of gaps between the mapped seeds; and
performing, at an alignment unit, the global alignment operation of the input read, with the reference sequence, in mapping positions in which the target seeds are mapped to the reference sequence;
wherein one or more of the seed generation unit, the filtering unit, and the alignment unit is implemented using a hardware processor.

6. The method of claim 5, wherein the selecting of the target seeds is performed by selecting ones of the mapped seeds, in which the sum of the gaps between the mapped seeds is less than or equal to a predetermined value.

7. The method of claim 6, wherein the selecting of the target seeds is performed by selecting ones of the mapped seeds, satisfying the following Expression:
A≦MaxError+B
where:
A represents the sum of the gaps between the selected seeds in the reference sequence,
B represents the sum of the gaps between the selected seeds in the read, and
MaxError represents a maximum error bound.

8. The method of claim 5, further comprising:
performing, at an exact matching unit, an exact matching of the input read with the reference sequence prior to generation of the seeds; and
estimating, at an error number estimation unit, a number of errors for the read, responsive to an indication by the exact matching unit that the read sequence does not exactly match the reference sequence, when aligned with the reference sequence,
wherein the generating of the plurality of seeds from the read is performed when the estimated number of errors is less than or equal to a predetermined maximum error bound.
